(19) United States
(12) Patent Application Publication
(10) Pub. No.: US 2020/0402154 A1
(43) Pub. Date: Dec. 24, 2020

(54) RESOURCE UTILIZATION MANAGEMENT PLATFORM

(71) Applicant: BANK OF AMERICA CORPORATION, Charlotte, NC (US)

(72) Inventors: Alicia C. Jones-McFadden, Fort Mill, SC (US); Katherine Dintenfass, Lincoln, RI (US)

(73) Assignee: BANK OF AMERICA CORPORATION, Charlotte, NC (US)

(21) Appl. No.: 16/446,864

(22) Filed: Jun. 20, 2019

(51) Int. Cl. G06Q 40/02; H04L 29/06

(52) U.S. Cl. CPC G06Q 40/02; H04L 63/102

(57) ABSTRACT

Embodiments of the invention are directed to a system, method, or computer program product for deferred resource management platform for individual users receiving term specific deferred resource opportunities. Upon receipt of a potential deferred resource, the system may specific criteria for receiving the resources in the future at a receiving entity. The system provides a trackable network for connections between parties to maintain a directory format for filtering and alerting the parties of criteria being reached, timelines, and the like associated with the resource distribution. The system provides proof of the criteria being reached and approves the resource distribution at the appropriate time.

### BACKGROUND

In technology landscapes, users regularly access entity applications to perform functions associated with the entity. That being said, in deferred relationships, technology is rarely implemented and, when implemented errors still occur in entity applications that disrupt user interaction and processing within the application. As such, there exists a need for an in line system for utilization management for deferred relationships.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention comprises a deferred resource management platform for individual users that may receive deferred resources with specific criteria for deployment type and deployment location of those resources at the specific future date to a receiver entity. Each user is provided with a platform identification number that corresponds to the user's account within the platform. The user and one or more guardians may have access to the account. Upon receipt of a potential deferred resource, the donor of the deferred resource may be provided with the platform identification in order to input the deferred resources for that user. The input may also include specific criteria for receiving the resources in the future at a receiving entity. This may include specific academic thresholds, athletic thresholds, secondary education location selections, or the like.

In this way, the system connects the donor, the user or recipient, and the receiving entity associated with the deferred resources such that the system coordinates distribution of the deferred resources at the appropriate time and location based on donor set criteria.

The system provides a trackable system for connections between the donor, user, and receiving entity to maintain a directory format for holding the deferred resources and ensure the resources are distributed at the appropriate time for the appropriate application. The system further provides a triggering mechanism for filtering and alerting the user, donor, and receiving entity of criteria being reached, timelines, and the like. The system provides proof of the criteria being reached and approves the resource distribution at the appropriate time.

In some embodiments, if the criteria are not satisfied and/or the resources are not utilized within a given time frame, the system may trigger a notification to the donor and allow the donor to provide the resources to another user or applicant.

Embodiments of the present invention address these and/or other needs by providing an innovative system, method and computer program product for deferred resource utilization, the invention comprising: generating a platform identification for a user; receiving multiple deferred resources for the user, wherein the deferred resource received includes terms and criteria for deployment at a deferred time, wherein multiple donors provide one or more of each of the multiple deferred resources; monitoring user activity to confirm terms and criteria maintenance for reach deferred resource; authorizing to a receiver entity the maintenance of the terms and criteria for the deferred resource; distributing resources associated with the deferred resource upon authorization to the receiver entity for a specified application; and identifying under-utilized resources for the specified application and transmit notification of the under-utilized resources to the donor for distribution to a second user or second specified application.

In some embodiments, under-utilized resources comprise resources over the amount of resources necessary for the specified application or resources where the user did not met the terms and criteria for deployment of the resources.

In some embodiments, the donor specifies the specific application for the receiver entity to apply the resources to on behalf of the user.

In some embodiments, terms and criteria for deployment at a deferred time further comprise current terms and criteria for the user to maintain and future terms and criteria for the user to achieve, wherein the terms and criteria comprises threshold levels of achievement for the user to obtain the deferred resource at a point in time in a future.

In some embodiments, the invention further comprises communicably linking the user, donor, and receiver entity and presenting information to the user, donor, and receiver entity via a user facing virtual system, wherein the communicable linking provides for selective communication to each of the user, donor, or receiver entity.

In some embodiments, the deferred resource is provided by a donor to the user. In some embodiments, the user is an individual receiving the deferred resource in a form of a scholarship for attending the receiver entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a resource utilization management platform system environment, in accordance with one embodiment of the present invention;

FIG. 2 provides a system process flow for communications across the resource utilization management platform system environment, in accordance with one embodiment of the present invention;

FIG. 3 provides a process flow for authentication and initiation to the resource utilization management platform, in accordance with one embodiment of the present invention;

FIG. 4 provides a process illustrating posting and processing a deferred resource within the resource utilization management platform, in accordance with one embodiment of the present invention;

FIG. 5 provides a process flow illustrating resource deployment within the resource utilization management platform, in accordance with one embodiment of the present invention; and

FIG. 6 provides a process flow illustrating user to user transitioning of deferred resources via the resource utilization platform, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

As described herein, a “user” is an individual associated with an entity. As such, in some embodiments, the user may be an individual having past relationships, current relationships or potential future relationships with an entity. A user may also be an individual receiving a deferred resource from a donor, such as an individual receiving a scholarship for academics or athletics for school. In some instances described herein, the user is an individual who seeks to utilize, operate, or perform one or more activities associated with a computer terminal, typically based on successful validation of the user's authentication credentials.

The term “computer terminal” as used herein may refer to one or more electronic devices that facilitate one or more user activities or transactions. Typically, a computer terminal is configured to facilitate performance of one or more user activities by establishing an “interactive session” between a user and the computer terminal. As such, the terms “user activity” or “user transaction” or simply “activity” may refer to financial or non-financial activities, tasks, events or actions. In some embodiments a computer terminal refers to one or more devices that facilitate execution of financial transactions or activities. That said, computer terminals may also refer to portable devices that facilitate financial and/or non-financial transactions, such as personal computers, laptop computers, tablet computers, smartphones, wearable devices, personal digital assistants (PDAs), and other computing devices. In some embodiments, the computer terminals may be owned, operated and/or otherwise associated entities and are installed at suitable locations, such that the user can travel to the location of the computer terminal to perform user activities or execute transactions. In some embodiments, the computer terminals may be owned, operated and/or otherwise associated with the user. In embodiments described herein, performing a user activity or transaction may refer to the initiation, stages during the processing, or completion of a transaction.

In some embodiments, as used herein a deferred resource is a resource that isn't accessible by the user until after a time period has passed and specific criteria have been met. A deferred resource is typically provided by a donor to a user. This may include a scholarship or the like. In some embodiments, as used herein a donor may be an individual, entity, corporation, charity, foundation, fund, trust, or the like that provides a deferred resource in the form of a scholarship to one or more users based on specific user criteria. In some embodiments, as used herein a receiver entity may be an entity that receives the deferred resources from the donor on behalf of the user. The receiver entity may be a school or the like.

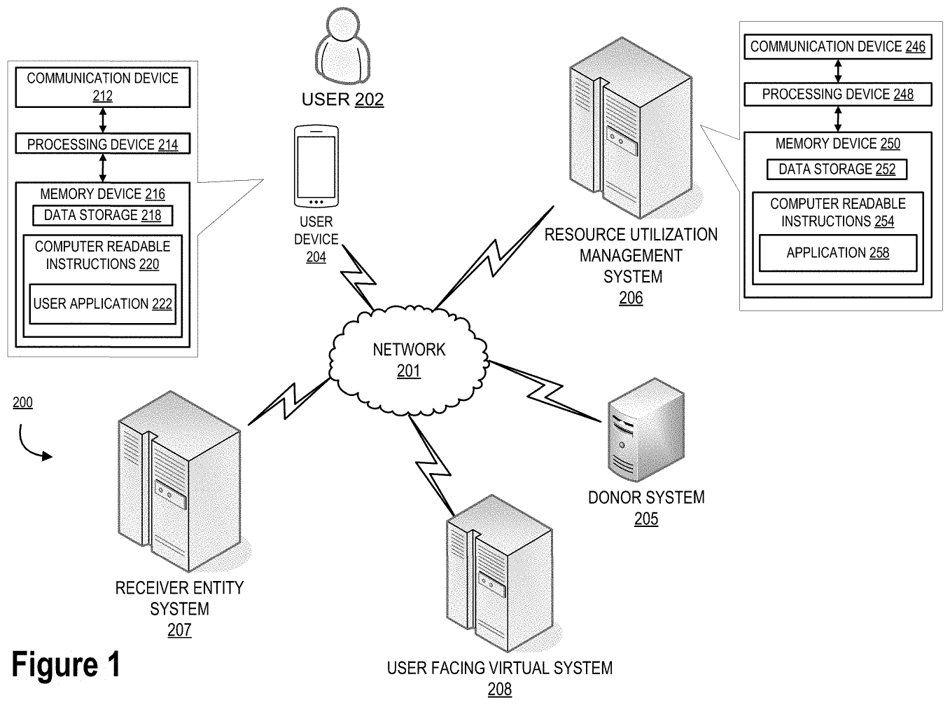

FIG. 1 provides a resource utilization management platform system environment 200, in accordance with one embodiment of the present invention. FIG. 1 provides the system environment 200 for which the distributive network system with specialized data feeds associated with an interconnected resource distribution and retention network. FIG. 1 provides a unique system that includes specialized servers and system communicably linked across a distributive network of nodes required to perform the functions described herein.

As illustrated in FIG. 1, the user facing virtual system 208 is operatively coupled, via a network 201 to the user device 204, donor system 205, receiver entity system 207, and to the resource utilization management system 206. In this way, the user facing virtual system 208 can send information to and receive information from the user device 204, donor system 205, receiver entity system 207, and the resource utilization management system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity that has one or more user devices 204 and is a receiving a deferred resource or has a platform identification. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the resource utilization management system 206, the user facing virtual system 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the resource utilization management system 206.

As further illustrated in FIG. 1, the resource utilization management system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the user facing virtual system 208, the receiver entity system 207, the donor system 205, and the user device 204. As such, the communication device 246 generally comprises a modem, server, or other device for communicating with other devices on the network 201.

As further illustrated in FIG. 1, the resource utilization management system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the resource utilization management system 206 the memory device 250 stores an application 258. In one embodiment of the invention, the application 258 may associate with applications having computer-executable program code. Furthermore, the resource utilization management system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more user facing virtual system 208, receiver entity system 207, donor system 205, and/or user device 204.

As illustrated in FIG. 1, the receiver entity system 207 is connected to the user facing virtual system 208, user device 204, donor system 205, and resource utilization management system 206. The receiver entity system 207 has the same or similar components as described above with respect to the user device 204 and the resource utilization management system 206. While only one receiver entity system 207 is illustrated in FIG. 1, it is understood that multiple receiver entity system 207 may make up the system environment 200. The receiver entity system 207 may be associated with one or more financial institutions, entities, or the like.

As illustrated in FIG. 1, the donor system 205 is connected to the user facing virtual system 208, user device 204, receiver entity system 207, and resource utilization management system 206. The donor system 205 has the same or similar components as described above with respect to the user device 204 and the resource utilization management system 206. While only one donor system 205 is illustrated in FIG. 1, it is understood that multiple donor system 205 may make up the system environment 200.

As illustrated in FIG. 1, the user facing virtual system 208 is connected to the receiver entity system 207, user device 204, donor system 205, and resource utilization management system 206. The user facing virtual system 208 may be associated with the resource utilization management system 206. The user facing virtual system 208 has the same or similar components as described above with respect to the user device 204 and the resource utilization management system 206. While only one user facing virtual system 208 is illustrated in FIG. 1, it is understood that multiple user facing virtual system 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The user facing virtual system 208 may generally include a processing device communicably coupled to devices as a memory device, output devices, input devices, a network interface, a power source, one or more chips, and the like. The user facing virtual system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the user facing virtual system 208 described herein.

The user facing virtual system 208 furthermore provides for establishing intelligent, proactive and responsive communication with a user, comprising a multi-channel cognitive resource platform for performing electronic activities in an integrated manner from a single interface. The user facing virtual system 208 is also configured for adapting to the user's natural communication and its various modes by allowing seamless switching between communication channels/mediums in real time or near real time”

The user facing virtual system 208 features include: User Interface Navigation and Activity Implementation, Cognitive, Intuitive and Anticipatory features and Electronic activity integration features.

The user facing virtual system 208 is configured to receive, recognize and interpret these linguistic phenomena of the user input and perform user activities accordingly. In this regard, the user facing virtual system 208 is configured for natural language processing and computational linguistics. Based on analyzing the received activity input, the user facing virtual system 208 is configured to determine the user activity that the user seeks to perform. Here, in general, the user facing virtual system 208 may parse the activity input from the user to detect one or more words that make up the activity input from the user. The user facing virtual system 208 may then analyze words to determine the user activity. For example, the user facing virtual system 208 may receive the following voice activity input from the user: “Pay my utility bill of February month.” The user facing virtual system 208 may then analyze the one or more words to determine that the caller wants to pay a bill, for example, based on identifying keywords such as, “pay” and “bill”. The user facing virtual system 208 may then proceed to perform the bill payment through the central user interface.

Specifically, based on receiving the activity input from the user, in some instances, the user facing virtual system 208 is configured to generate a parse tree based on detected one or more words and/or the detected keywords. A parse tree is a data structure that allows the user facing virtual system 208 to accurately analyze activity input. For example, the parse tree may indicate the various language structures, such as clauses, phrases, subjects, verbs, and objects in a spoken statement and identify the words in each language structure. The user facing virtual system 208 may analyze the parse tree to determine the user activity to be performed and the intent of the user and also to determine any parameters provided by the user for an invoked service. The user facing virtual system 208 may invoke another application, a service, an activity functionality and the like based on its analysis of parse tree.

The user facing virtual system 208 is configured for initiate presentation of a central user interface of the multi-channel cognitive resource application stored on the user device. The user facing virtual system 208 may receive user input. For example, this input may be received via an audio communication channel and/or a textual communication channel. The user facing virtual system 208 may be configured to interpret and transform, seamlessly and in real-time, one medium to another for presentation on the central user interface (for example, speech to text, text to speech and the like). The user facing virtual system 208 may present the received activity input from the user in a textual format. The user facing virtual system 208 may similarly respond to the user input, as indicated by the output, in natural language. In addition, the user facing virtual system 208 may present one or more interactive elements for facilitating the activity, which are embedded, integrated into, or overlaid over the central user interface. These interactive elements may be actuated by tactile input (touch commands and other gestures), audio commands or textual input from the user. These interactive elements may be extracted from other pertinent applications, such as resource applications, discussed previously.

In addition, the user facing virtual system 208 is intuitive and is configured to hold complex and branched conversations with the user, in the pursuit of completing one or more user activities. In this regard, the user facing virtual system 208 is configured to detect and conduct branched conversations using intelligent complex path looping. In some instances, the user facing virtual system 208 may identify a suitable conversation path for completion of a user initiated activity, and proceed to request information accordingly. For example, for a user activity of making reservations at a restaurant, the user facing virtual system 208 may determine a conversation path comprising requesting the cuisine of the restaurant, presenting one or more restaurants associated with the cuisine located in the user's vicinity, receiving a selection of a particular restaurant, receiving a time for the reservation and the number of people for the reservation, and the like. Subsequently, the user facing virtual system 208 may automatically make reservations for the user at the chosen restaurant. These conversation paths are typically natural language conversational forms of the user activity events described previously, and may be determined by the user facing virtual system 208, after or in conjunction with determining the one or more discrete activity events.

In addition, the intelligent complex path looping of the invention enables the user facing virtual system 208 to loop back to the original conversation path for completion of the activity in the instances where the user digresses or the conversation branches out.

Furthermore, the user facing virtual system 208 may include an enhanced resource sharing management application, is configured to function as an intelligent personal assistant and resource navigator and is configured to perform one or more resource activities by harnessing the functionality of multiple applications resident on the user device, for example, functionality of a resource sharing application and another resource activity application may be proactively provided on a single interface, for example, via interfaces overlaid over each other.

Here, in some instances, the central user interface is a computer human interface, and specifically a natural language user interface for receiving user input (for example, for creating, selecting and modifying data/functionality), presenting information regarding user activities, providing output to the user, and otherwise communicating with the user in a natural language of the user. The natural language of the user comprise linguistic phenomena such as verbs, phrases and clauses that are associated with the natural language of the user. The user facing virtual system 208 is configured to receive, recognize and interpret these linguistic phenomena of the user input and perform user activities accordingly. In this regard, the user facing virtual system 208 is configured for natural language processing and computational linguistics. In many instances, the user facing virtual system 208 is intuitive, and is configured to anticipate user requirements, data required for a particular activity and the like, and request activity data from the user accordingly.

In particular, the user facing virtual system 208 is configured to present an integrated central user interface for communicating with the user using audio, visual, and/or textual natural speech conversations with the user, for execution of one or more user activities such as resource sharing and allocation, communicating and performing associated resource activities and functions, and for integrating the functionality of multiple applications (e.g., a resource sharing application such as a resource availability/surplus identification and allocation application for renting dwellings, and a resource activity application such as a financial application, an incentive/offer application and/or a personal assistant application) in a single interface, without requiring the user to access the multiple applications individually and be proficient in their operation.

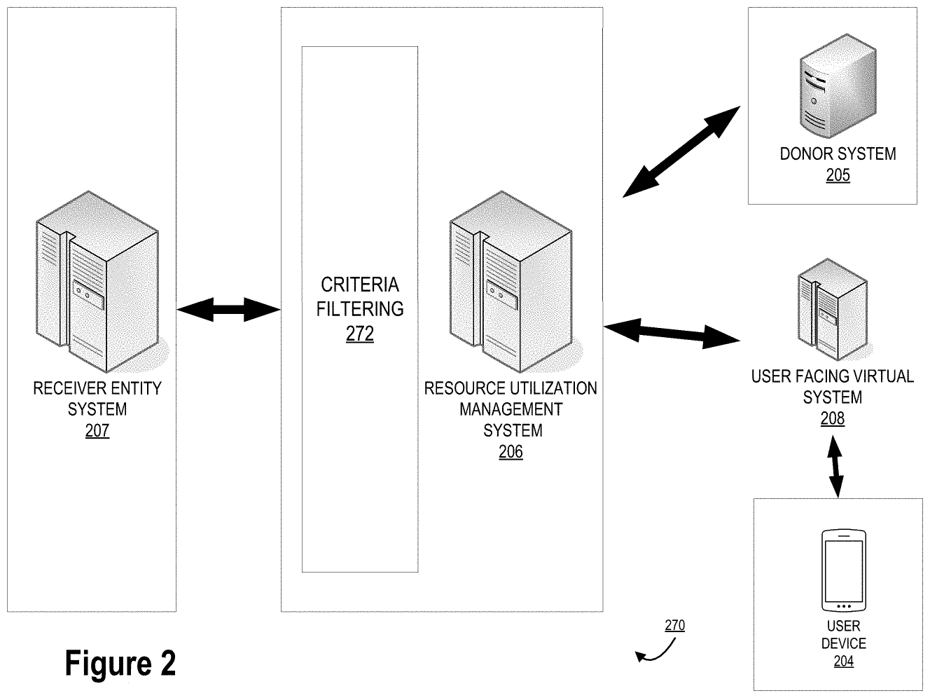

FIG. 2 provides a system process flow for communications across the resource utilization management platform system environment 270, in accordance with one embodiment of the present invention. As illustrated, the resource utilization management system 206 stores, monitors, and maintains any deferred resources and the distribution of those resources between the parties. A user may enroll with the resource utilization management system 206 and receive a platform identification number. The user may communicate via the user device 204 associated with the user. The resource utilization management system 206 may utilize a user facing virtual system 208 associated with the resource utilization management system 206 in order to provide a user interface to the user on his/her user device 204. The user facing virtual system 208 allows the resource utilization management system 206 to present data via multiple channels, such as audio, textual, video, augmented, or the like.

Furthermore, the donor system 205, which is associated with the donor of the deferred resources may be in communication with the resource utilization management system 206 in order to provide terms of the deferred resources. These terms or criteria may include a type of school, an amount, an academic threshold, an athletic threshold, specify resource distribution uses, or the like. The terms may also require the user to maintain specific levels before the distribution and after the distribution. The resource utilization management system 206 may receive the terms and confirm the terms are met prior to each distribution of deferred resources.

In some embodiments, the resource utilization management system 206 may continually monitor the terms set by the donor via the donor system 205 and perform criteria filtering 272 prior to transmission of communications or resources to the receiving entity system 207. Upon successful meeting of the terms, the resource utilization management system 206 may transmit resources directly to the receiver entity system 207 based on a confirmation of the terms being met, proper timing for distribution, and the resource utilization management system 206 may tag the resources being distributed for a specific application.

The invention comprises a deferred resource management platform for individual users that may receive deferred resources with specific criteria for deployment type and deployment location of those resources at the specific future date to a receiver entity. Each user is provided with a platform identification number that corresponds to the user's account within the platform. The user and one or more guardians may have access to the account. Upon receipt of a potential deferred resource, the donor of the deferred resource may be provided with the platform identification in order to input the deferred resources for that user. The input may also include specific criteria for receiving the resources in the future at a receiving entity. This may include specific academic thresholds, athletic thresholds, secondary education location selections, or the like.

In this way, the system connects the donor, the user or recipient, and the receiving entity associated with the deferred resources such that the system coordinates distribution of the deferred resources at the appropriate time and location based on donor set criteria.

The system provides a trackable system for connections between the donor, user, and receiving entity to maintain a directory format for holding the deferred resources and ensure the resources are distributed at the appropriate time for the appropriate application. The system further provides a triggering mechanism for filtering and alerting the user, donor, and receiving entity of criteria being reached, timelines, and the like. The system provides proof of the criteria being reached and approves the resource distribution at the appropriate time.

In some embodiments, if the criteria are not satisfied and/or the resources are not utilized within a given time frame, the system may trigger a notification to the donor and allow the donor to provide the resources to another user or applicant.

In this way, the system provides a platform for scholarship routing and connections. Scholarship awards typically require specific criteria for a user to be a recipient of the scholarship. This system comprises a platform where scholarship recipients, donors, and schools may be able to interact to ensure criteria met, funds distributed, and fund appropriation correctly based on rules and regulations. The system may dynamically track scholarship usage against rules to determine if funds are used appropriately.

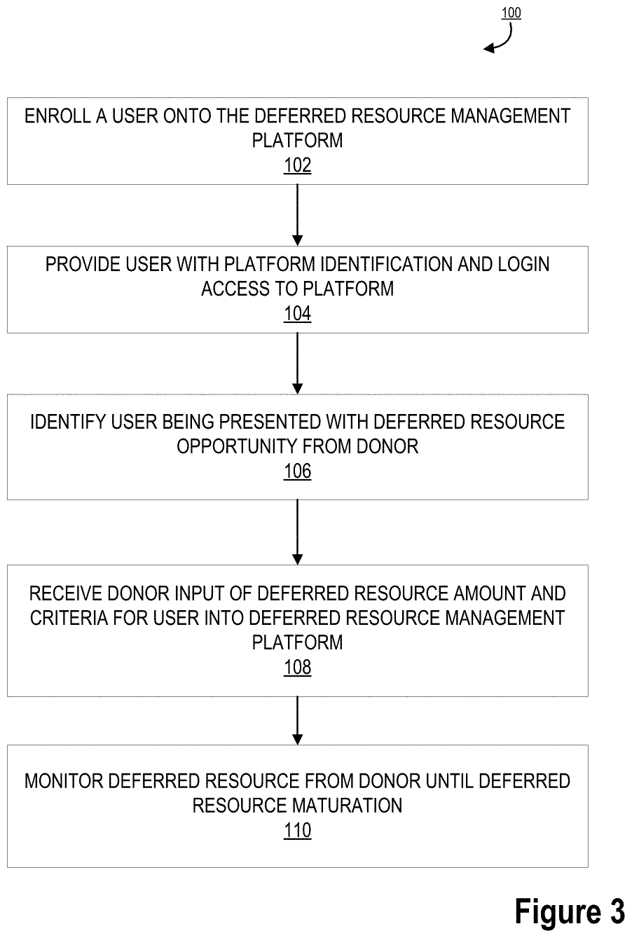

FIG. 3 provides a process flow for authentication and initiation to the resource utilization management platform 100, in accordance with one embodiment of the present invention. As illustrated in block 102, the process 100 is initiated by authenticating a user on the deferred resource management platform. In this way, the user may enroll and sign up for the deferred resource management system and/or a donor may request a user enroll. The user and the user's guardians may have access to the platform upon enrollment. Upon enrollment, the user may receive a platform identification and be able to electronically log into the platform, as illustrated in block 104. The platform identification may be a unique reference number or alpha numeric code associated with the user. The platform identification is similar to an account number in that it is unique to the user and is used to process and associate the deferred resources with the user.

As illustrated in block 106, the process 100 continues by identifying that a user is being presented with one or more deferred resource opportunities from one or more donors. In some embodiments, the user may notify the system of the deferred resource opportunity. In some embodiments, the donor may notify the system of the deferred resource opportunity. In some embodiments, the system may identify the deferred resource opportunity. In this way, the system may identify the deferred resource opportunity based on news, social media, press conferences, or the like notifying of the user's deferred resource opportunity.

As illustrated in block 108, the process 100 continues by receiving the donor input of the deferred resource amount and criteria for the user. The donor may input a resource amount, a term, and criteria for the resource amount to be distributed. The criteria may require a user to maintain a specific academic or athletic status for a duration of time until the resources may be deployed. For example, the user may be required to maintain a specific grade point average upon graduation of high school in order to maintain and receive a college scholarship. The resources may also have a time deployment criteria. In this way, resources may be distributed over the course of many months/years based on the user meeting the necessary criteria to receive the resources. For example, a user in college must maintain a specific grade point average in a first semester to receive the resource deployment in the second semester.

Finally, as illustrated in block 110, the process 100 is completed upon monitoring of the deferred resources from the donor until the deferred resources maturate and all criteria are met. As such, upon maturation and criteria matching, the system may disperse the resources to the appropriate receiver entity, such as a university or the like. The dispersing may be to purchase or be applied to a specific item, like books, room, board, or the like.

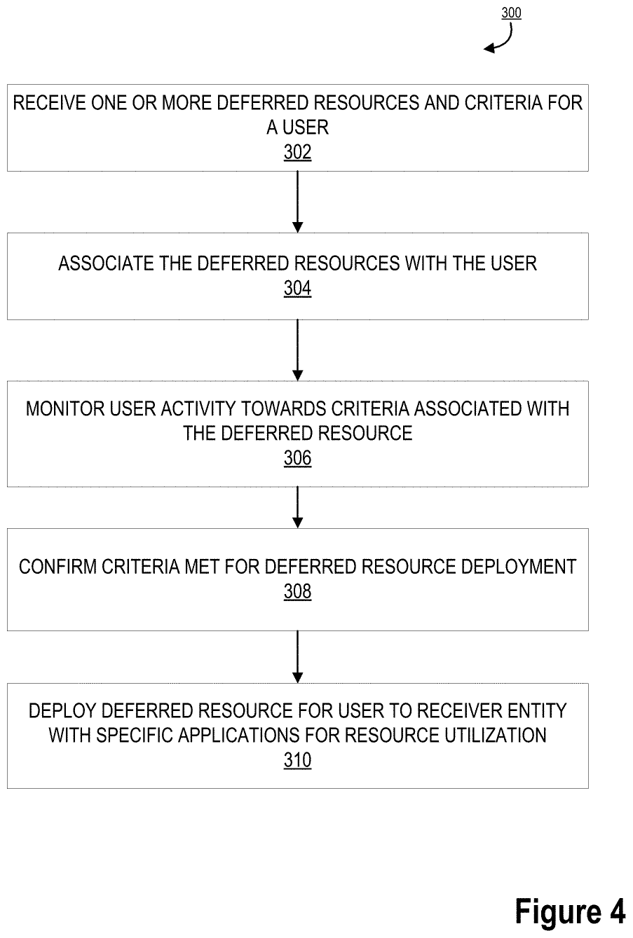

FIG. 4 provides a process illustrating posting and processing a deferred resource within the resource utilization management platform 300, in accordance with one embodiment of the present invention. As illustrated in block 302, the process 300 is initiated by receiving one or more deferred resources and criteria for a user. In this way, the user or user guardian may communicate with the system to present to deferred resources and criteria to the system. The system may then communicate with the donor to confirm the resource amount, time frame, and criteria for distribution. In some embodiments, the system may receive one or more deferred resources and criteria for a user from the donor directly. In this way, the donor may provide the resource amount, time frame, and criteria for distribution upon input of the deferred resources to the system.

As illustrated in block 304, the process 300 continues by associating the deferred resource with the appropriate user, donor, and receiver entity. In this way, the system may communicably link the user, donor, and receiver entity. The system may not allow for the various parties to communicate to each other directly. However, the system may trigger specific communications to each party based on criteria, status, or the like.

The system may continue to monitor user activity towards the criteria associated with the deferred resource, as illustrated in block 306. In this way, the deferred resource may not mature for several months or years. In that time, the user may be required to maintain specific criteria. The system may monitor the user's actions to confirm maintenance of or reaching of the criteria.

Upon maturation of the deferred resource, the system may confirm that the criteria has been met by the user and/or receiver entity for the deferred resources to be deployed, as illustrated in block 308. In this way, the system may confirm with the donor that the criteria has been met and that the user is currently enrolled with the receiver entity. As such, the system may distribute resources for the specified application to the receiver entity, as illustrated in block 310. In some embodiments, if the resources are over the application, the system may communicate that back to the donor and allow donor selection of a second application for the resources and/or a second user to distribute the additional resources.

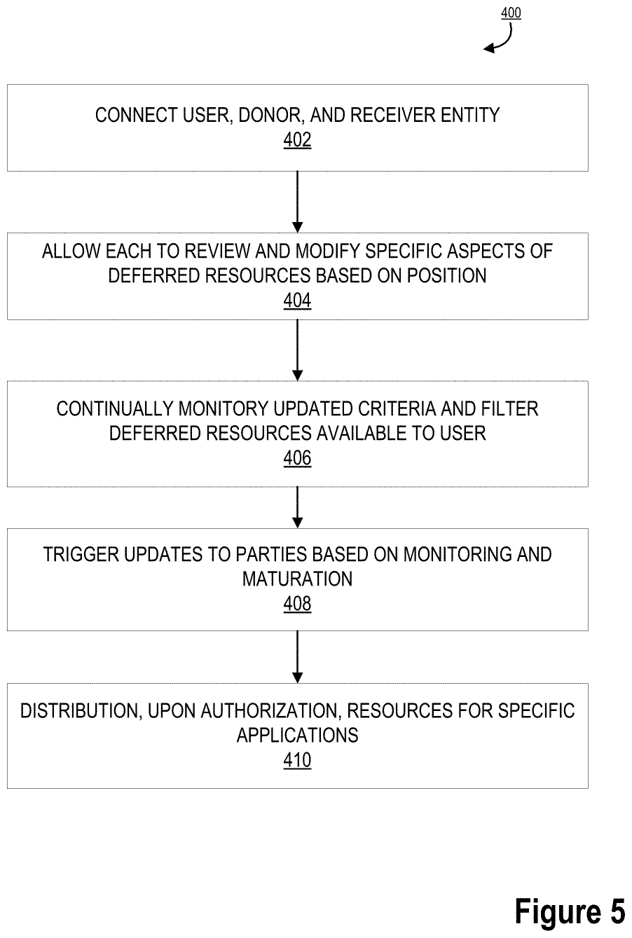

FIG. 5 provides a process flow illustrating resource deployment within the resource utilization management platform 400, in accordance with one embodiment of the present invention. As illustrated in block 402, the process 400 is initiated by providing an interconnection between a user, a donor, and the receiver entity. In this way, each can communicate directly with the system. The system may then be able to provide necessary updates to the one or more other parties depending on the initial communication. In this way, as illustrated in block 404, the system allows for each of the user, donor, and receiver entity to review and modify specific aspects of the deferred resource distribution based on the party's position and the current point in the lifespan of the deferred resource. In some embodiments, the user may modify which receiver entity receives the deferred resource, provides an update on maintaining criteria for receiving the resource, and the like. In some embodiments, the receiver entity may provide an indication of an amount of resources needed for a specific application, if there are too many or too few resource for the application, current user status with the receiver entity, and the like. In some embodiments, the donor may provide information about which criteria the user may need to maintain or reach, the amount of the resources for the deferred resources, the application of those resources, the timing for deployment of those resources, and specific receiver entities that may accept the resources.

Next, as illustrated in block 406, the process 400 continues by continually monitoring updated criteria and filter the deferred resources available to the user. As such, the system may continually monitor the user activities to confirm successful maintenance of the criteria. Upon changes occurring or upon maturation, the system may trigger updates to the parties associated with the deferred resource distribution, as illustrated in block 408. As such, based on changes, the system may provide specific updates to the specific parties based on if that particular party needs to know the information from the update.

Finally, as illustrated in block 410, the process 400 is finalized by distributing, upon authorization, resources for specific applications at the receiver entity. In this way, the system may distribute the resources to the receiver entity and trigger a specific application for those resources. This may include applications such as credit hours, room/board, or the like.

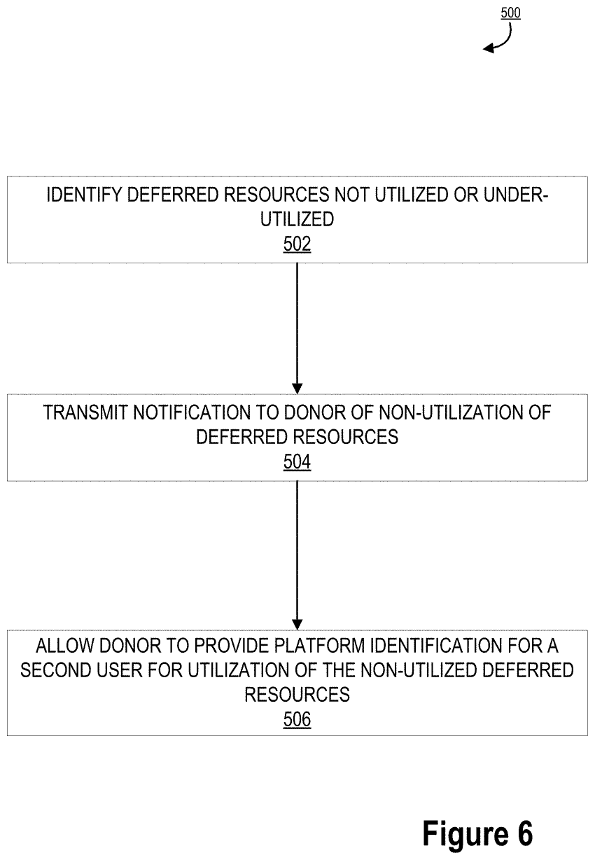

FIG. 6 provides a process flow illustrating user to user transitioning of deferred resources via the resource utilization platform 500, in accordance with one embodiment of the present invention. As illustrated in block 502, the process 500 is initiated by identifying deferred resources not utilized or under-utilized.

In some embodiments, the receiver institution may identify not utilized or under-utilized resources. In this way, the receiver institution may identify one or more extra resources that are not being used for the specific requested application. As such, these may be under-utilized resources. In some embodiments, the receiver entity may identify that the user is no longer enrolled or eligible for resources based on receiver entity criteria.

In some embodiments, the donor may identify not utilized or under-utilized resources. In this way, the donor may identify that the user has not completed one or more of the criteria that are required for the user to maintain in order to complete and receive the deferred resources.

Next, as illustrated in block 504, the process 500 continues by transmitting a notification to the donor of the non-utilized deferred resources resulting from the not utilized or under-utilized resources identified by the receiver entity and/or the donor. The system may transmit the notification to the donor via a donor device. The system may then allow the donor to provide a second user for utilization of the non-utilized deferred resources and/or the donor may request the resources back, as illustrated in block 506.

In some embodiments, the system may maintain the resources during the process. As such, the system may invest or otherwise maintain the resources prior to deployment of the resources to the receiver entity. The system may pool resources from one or more users in order to better maintain interest and the like associated with the resources.

The invention comprises a deferred resource management platform for individual users that may receive deferred resources with specific criteria for deployment type and deployment location of those resources at the specific future date to a receiver entity. Each user is provided with a platform identification number that corresponds to the user's account within the platform. The user and one or more guardians may have access to the account. Upon receipt of a potential deferred resource, the donor of the deferred resource may be provided with the platform identification in order to input the deferred resources for that user. The input may also include specific criteria for receiving the resources in the future at a receiving entity. This may include specific academic thresholds, athletic thresholds, secondary education location selections, or the like.

In this way, the system connects the donor, the user or recipient, and the receiving entity associated with the deferred resources such that the system coordinates distribution of the deferred resources at the appropriate time and location based on donor set criteria.

The system provides a trackable system for connections between the donor, user, and receiving entity to maintain a directory format for holding the deferred resources and ensure the resources are distributed at the appropriate time for the appropriate application. The system further provides a triggering mechanism for filtering and alerting the user, donor, and receiving entity of criteria being reached, timelines, and the like. The system provides proof of the criteria being reached and approves the resource distribution at the appropriate time.

In some embodiments, if the criteria are not satisfied and/or the resources are not utilized within a given time frame, the system may trigger a notification to the donor and allow the donor to provide the resources to another user or applicant.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for deferred resource utilization, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
generate a platform identification for a user;
receive multiple deferred resources for the user, wherein the deferred resource received includes terms and criteria for deployment at a deferred time, wherein multiple donors provide one or more of each of the multiple deferred resources;
monitor user activity to confirm terms and criteria maintenance for reach deferred resource;
authorize to a receiver entity the maintenance of the terms and criteria for the deferred resource;
distribute resources associated with the deferred resource upon authorization to the receiver entity for a specified application; and
identify under-utilized resources for the specified application and transmit notification of the under-utilized resources to the donor for distribution to a second user or second specified application.

2. The system of claim 1, wherein under-utilized resources comprise resources over the amount of resources necessary for the specified application or resources where the user did not met the terms and criteria for deployment of the resources.

3. The system of claim 1, wherein the donor specifies the specific application for the receiver entity to apply the resources to on behalf of the user.

4. The system of claim 1, wherein terms and criteria for deployment at a deferred time further comprise current terms and criteria for the user to maintain and future terms and criteria for the user to achieve, wherein the terms and criteria comprises threshold levels of achievement for the user to obtain the deferred resource at a point in time in a future.

5. The system of claim 1, further comprising communicably linking the user, donor, and receiver entity and presenting information to the user, donor, and receiver entity via a user facing virtual system, wherein the communicable linking provides for selective communication to each of the user, donor, or receiver entity.

6. The system of claim 1, wherein the deferred resource is provided by a donor to the user.

7. The system of claim 1, wherein the user is an individual receiving the deferred resource in a form of a scholarship for attending the receiver entity.

8. A computer program product for deferred resource utilization, the computer program product comprising at least one non-transitory computer-readable medium having computer-readable program code portions embodied therein, the computer-readable program code portions comprising:
an executable portion configured for generating a platform identification for a user;
an executable portion configured for receiving multiple deferred resources for the user, wherein the deferred resource received includes terms and criteria for deployment at a deferred time, wherein multiple donors provide one or more of each of the multiple deferred resources;
an executable portion configured for monitoring user activity to confirm terms and criteria maintenance for reach deferred resource;
an executable portion configured for authorizing to a receiver entity the maintenance of the terms and criteria for the deferred resource;
an executable portion configured for distributing resources associated with the deferred resource upon authorization to the receiver entity for a specified application; and
an executable portion configured for identifying under-utilized resources for the specified application and transmit notification of the under-utilized resources to the donor for distribution to a second user or second specified application.

9. The computer program product of claim 8, wherein under-utilized resources comprise resources over the amount of resources necessary for the specified application or resources where the user did not met the terms and criteria for deployment of the resources.

10. The computer program product of claim 8, wherein the donor specifies the specific application for the receiver entity to apply the resources to on behalf of the user.

11. The computer program product of claim 8, wherein terms and criteria for deployment at a deferred time further comprise current terms and criteria for the user to maintain and future terms and criteria for the user to achieve, wherein the terms and criteria comprises threshold levels of achievement for the user to obtain the deferred resource at a point in time in a future.

12. The computer program product of claim 8, further comprising an executable portion configured for communicably linking the user, donor, and receiver entity and presenting information to the user, donor, and receiver entity via a user facing virtual system, wherein the communicable linking provides for selective communication to each of the user, donor, or receiver entity.

13. The computer program product of claim 8, wherein the deferred resource is provided by a donor to the user.

14. The computer program product of claim 8, wherein the user is an individual receiving the deferred resource in a form of a scholarship for attending the receiver entity.

15. A computer-implemented method for deferred resource utilization, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating a platform identification for a user;
receiving multiple deferred resources for the user, wherein the deferred resource received includes terms and criteria for deployment at a deferred time, wherein multiple donors provide one or more of each of the multiple deferred resources;
monitoring user activity to confirm terms and criteria maintenance for reach deferred resource;
authorizing to a receiver entity the maintenance of the terms and criteria for the deferred resource;
distributing resources associated with the deferred resource upon authorization to the receiver entity for a specified application; and
identifying under-utilized resources for the specified application and transmit notification of the under-utilized resources to the donor for distribution to a second user or second specified application.

16. The computer-implemented method of claim 15, wherein under-utilized resources comprise resources over the amount of resources necessary for the specified application or resources where the user did not met the terms and criteria for deployment of the resources.

17. The computer-implemented method of claim 15, wherein the donor specifies the specific application for the receiver entity to apply the resources to on behalf of the user.

18. The computer-implemented method of claim 15, wherein terms and criteria for deployment at a deferred time further comprise current terms and criteria for the user to maintain and future terms and criteria for the user to achieve, wherein the terms and criteria comprises threshold levels of achievement for the user to obtain the deferred resource at a point in time in a future.

19. The computer-implemented method of claim 15, further comprising communicably linking the user, donor, and receiver entity and presenting information to the user, donor, and receiver entity via a user facing virtual system, wherein the communicable linking provides for selective communication to each of the user, donor, or receiver entity.

20. The computer-implemented method of claim 15, wherein the user is an individual receiving the deferred resource in a form of a scholarship for attending the receiver entity.
